(19) United States
(12) Patent Application Publication
(10) Pub. No.: US 2006/0099052 A1
(43) Pub. Date: May 11, 2006

(54) Document binder for covers with heat activated adhesive

(76) Inventor: James Mark Folster Johnstone, Kwa-Zulu Natal Province (ZA)

Correspondence Address: WOOD, HERRON & EVANS, LLP, 2700 CAREW TOWER, 441 VINE STREET, CINCINNATI, OH, 45202, US

(21) Appl. No.: 10/543,233

(22) PCT Filed: May 28, 2003
(86) PCT No.: PCT/ZA03/00070

§ 371 Date: Jul. 22, 2005

(30) Foreign Application Priority Data
Feb. 20, 2003 (ZA) 2003/1374

(51) Int. Cl. B42C 9/00

(52) U.S. Cl. 412/9

(57) ABSTRACT

A document binder of the type comprising a chassis (12) adapted to removably receive either a plurality of covers (11) with associated document pages therein with spines (10) of the covers in a generally lowermost position or to removably receive a cassette (1) configured to hold such plurality of covers, and a generally horizontal heated plate (18) that operatively engages the spines of the plurality of covers to heat same when enganged wherewith in consequence of appropriate relative movement of the heated plate and spines of the covers I an upwards and downwards direction is provided. The document binder has a cradle (14) adapted to removably receive the covers or cassette with the cradle being pivotally moutned (17) to the chassis so as to be movable between two positions, a first loading position in which the cradle is positioned in an upwardly and outwardly inclined orientation for enabling a plurality of covers or a cassette being movable of to be loaded into the cradle or removed therefrom, and a second, generally horizontal and lower operative position in which the cradle supports the covers or cassette carrying same with spines of covers carried in the cradle in contact with the heated plate.

### FIELD OF THE INVENTION

This invention relates to a document binder for use in effecting the binding of a sheaf of document pages or other sheets of paper in a prefabricated cover consisting of a front and rear cover sheet, joined together along the operatively rear edge by a spine. The inside surface of the spine has thereon a heat activated adhesive, usually in the form of a hot melt type of adhesive. The spines, and often also the cover sheets, are generally made of paper board and/or plastics material and the spine is usually of a channel shape of a width that varies according to the number of pages or sheets to be bound therein.

More particularly the invention relates to a document binder of the general nature described in my granted South African patent No 2001/9532 dated 20 Nov. 2001 and having an identical title to the present application. The disclosure in my said earlier patent is incorporated herein by reference.

### BACKGROUND TO THE INVENTION

The document binder described and claimed in my said earlier patent operates effectively and is highly satisfactory in operation in appropriate applications. However, the need for a yet smaller and simpler document binder became apparent during marketing exercises.

### OBJECT OF THE INVENTION

It is, accordingly, an object of this invention to provide a document binder of the general nature described in my said earlier patent but one that can be designed to be simpler in construction and, accordingly, less costly.

### SUMMARY OF THE INVENTION

In accordance with this invention there is provided a document binder of the type comprising a chassis adapted to removably receive either a plurality of covers with associated document pages therein with spines of the covers in a generally lowermost position or to removably receive a cassette configured to hold such plurality of covers, and a generally horizontal heated plate that operatively engages the spines of the plurality of covers to heat same when engaged therewith in consequence of appropriate relative movement of the heated plate and spines of the covers in an upwards and downwards direction, the document binder being characterized in that it has a cradle adapted to removably receive said plurality of covers or cassette containing same with the cradle being pivotally mounted to the chassis so as to be pivotally moveable between two positions, a first, loading position in which the cradle is positioned in an upwardly and outwardly inclined orientation for enabling a plurality of covers or a cassette containing such plurality of covers to be loaded into the cradle or removed therefrom, and a second, generally horizontal and lower operative position in which the cradle supports the covers or cassette carrying same with spines of covers carried in the cradle in contact with the heated plate.

Further features of the invention provide for the cradle to be particularly configured to removably receive a cassette having a series of compartments defined between a series of spaced dividers; for the heated plate to be supported by the chassis through resilient support means enabling it to be vibrated or jogged to effect jogging of the covers during or following a heating cycle, or both; for the means for jogging the heated plate to be a generally horizontal drive shaft having an eccentric weight thereon; for the pivotal axis of movement of the cradle to be positioned generally horizontally and forwards of the nearest part of a compartment for operatively receiving a cover so that pivotal movement between the operative position and the loading position lifts the document spines off the heated plate; and for movement of the cradle between the operative and loading positions to be effected by means of a chain drive positioned on one side wall of the chassis and driven by a reversible motor controlled by way of limit switches associated with a chain assembly.

The invention still further provides a document binder as defined above in which there is included control means for controlling operation of the document binder, said control means being adapted to initiate jogging a predetermined time after the cradle has arrested in its operative position in which the spines of covers that are loaded in the cradle male contact with the heated plate; to continue jogging for a predetermined period of time; and to initiate movement of the cradle from its operative position to its inoperative position after a total predetermined time period after the cradle arrested in its operative position.

In order that the above and other features of the invention may become more apparent one embodiment thereof will now be described with reference to the accompanying drawings.

### BRIEF DESCRIPTION OF THE DRAWINGS

In the drawings:—

FIG. 1 is a schematic side elevation of one embodiment of the invention with the cradle in its operative position;

FIG. 2 is a view similar to FIG. 1 but illustrating the cradle in its loading position;

FIG. 3 is a side view of one sidewall of the chassis and illustrating schematically the drive mechanism for moving the cradle between its operative and loading positions;

FIG. 4 is a schematic sectional elevation taken through the cradle, a cassette and the heated plate mechanism of the document binder;

FIG. 5 is an enlarged detail illustrating the manner of support of one corner of a cover relative to the cradle and heated plate in the operative position;

FIG. 6 is a schematic elevation similar to FIG. 4 but illustrating a variation applied to a cassette to bind documents in covers that do not extend the full width of the cassette;

FIG. 7 is a schematic plan view of the document binder; and,

FIG. 8 is a schematic orthographic projection of a cassette suitable for use in conjunction with the document binder.

### DETAILED DESCRIPTION WITH REFERENCE TO THE DRAWINGS

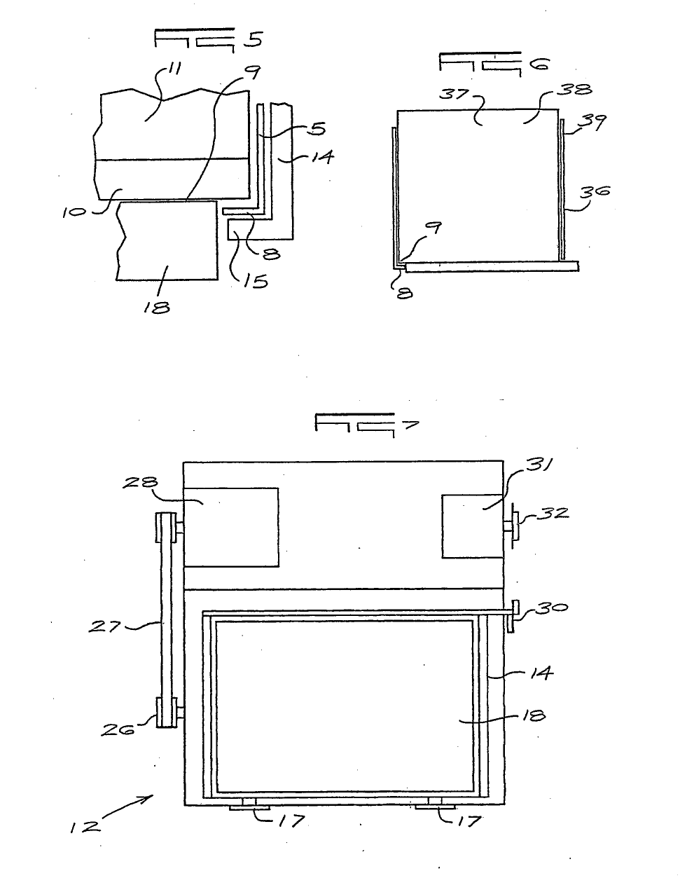

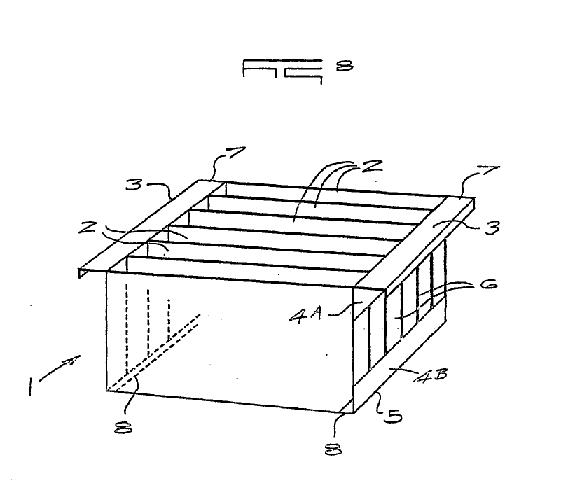

In the particular embodiment of the invention illustrated in the drawings and described hereinafter, the document binder is adapted to be used with cassettes substantially as described in my said granted patent apart from the fact that the wheels referred to in that patent are omitted as being unnecessary and the height of the cassettes does not need to be selected to enable a top jogger plate to contact the upper edges of the covers. The cassette, generally indicated by (1), and illustrated in FIG. 8, can thus comprise a series of parallel divider plates (2) spaced apart to define a series of compartments between them as described in my earlier patent. The plates may be interconnected at their upper ends by an upper frame member (3) that defines the upper part (4a) of a sidewall, and at their lower ends by a lower frame member (5) which defines the lower portion (4b) to the side wall. In this construction a portion (6) sidewall is left open, as being the most economical construction, but if required the entire side will could be closed. The upper frame member (3) has a generally horizontal outwardly directed flange (7) for use as a handle and the lower frame member (5) has an inwardly directed lip (8) for supporting the ends (9) of the spine (10) of a cover (11) (see FIG. 5).

It is to be understood that the cradle of the document binder described below could itself be configured in this manner in the case of a document binder to be used for extremely low production capacity in which case the covers and associated documents would be loaded directly into compartments provided in the cradle.

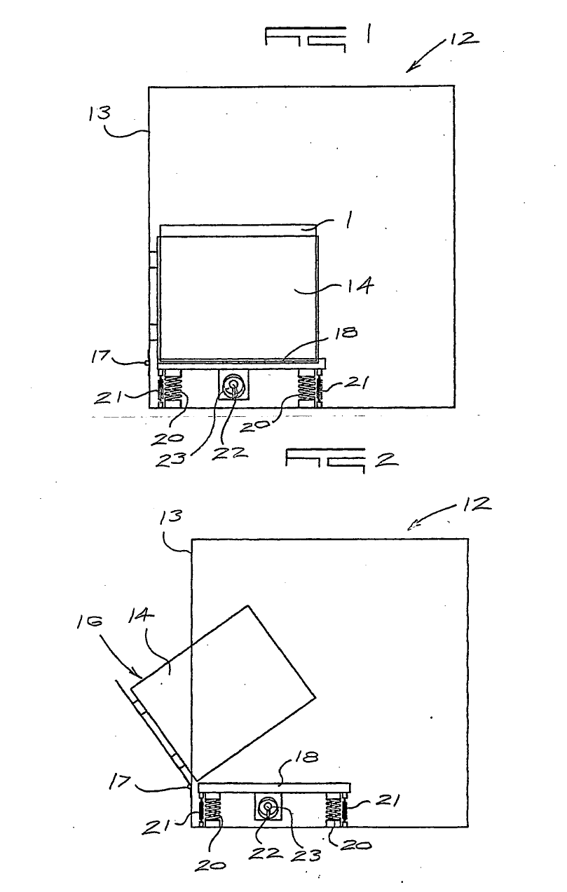

Reverting, however, to the present embodiment of the invention, the document binder has a chassis generally indicated by numeral (12) having a front (13) that has associated with it a pivotally mounted cradle (14). The cradle is configured with a pair of inwardly directed lips (15) at its lower opposite edges with the lips (15) being arranged to support the lips (8) of the cassette, in use. The cradle is pivotally movable between an inner, operative position in which it is generally horizontal and positioned within the chassis, as illustrated in FIG. 1, and a forwardly and upwardly inclined loading position in which the cradle is partially out of the chassis and a cassette can be loaded into or removed from the cradle by way of its upper periphery (16).

The hinges (17) attaching the cradle to the chassis are located forwardly of the nearest side of the cradle and cassette to ensure that rotation from the operative position to the inoperative position lifts even the closest cover and associated documents off the heated plate (18) that is carried by the chassis and operatively positioned between the opposite lips of the cradle and cassette as shown most clearly in FIG. 4.

The heated plate, in contradistinction to that described in my said granted patent, does not need to move vertically in order to contact the spines of covers held in a cassette in the operative position of the cradle in consequence of the necessary vertical movement being achieved by the pivotal movement of the cradle. This being so, the heated plate is resiliently supported in its position by four compression springs (20) positioned approximately at the corners of the plate and by two tension springs (21) positioned roughly midway along the front and rear edges of the heated plate.

A vibratory or jogging movement can thus be applied to the heated plate in order to effect jogging of the covers and their associated documents as and when required. This is achieved by means of a generally horizontal jogger shaft (22) that has an eccentric weight (23) and is held relative to the plate in a suitable bearing (24). A flexible drive shaft (25) connects the jogger shaft (22) with a drive shaft (26) driven through a belt drive (27) by a suitable motor (28). The speed of the jogger shaft is typically about 2000 rpm when activated.

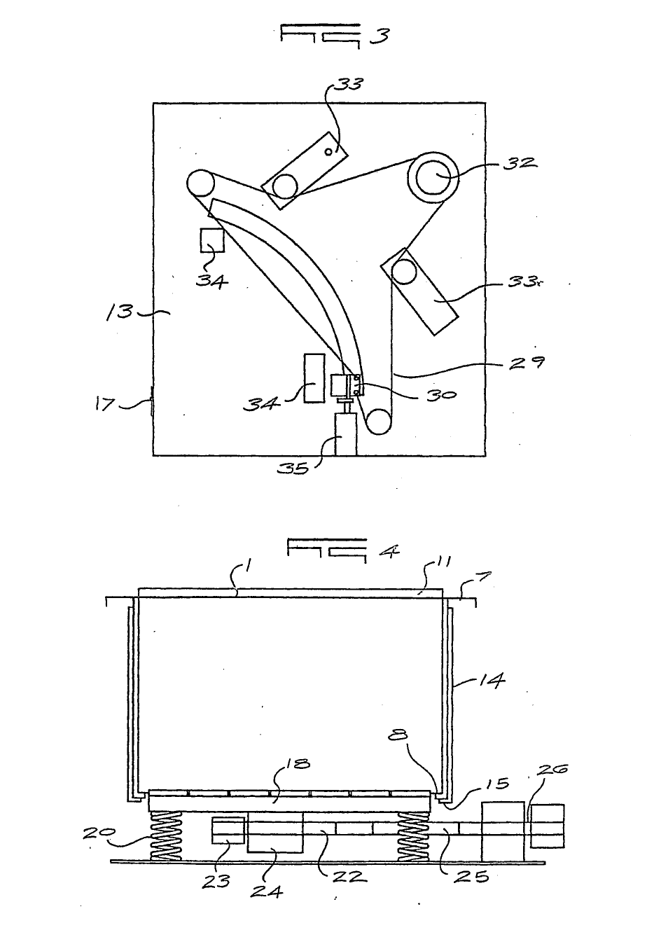

Finally, for completeness of description, the cradle is rotated between its two terminal positions by means of a mechanism illustrated in FIG. 3 that includes a drive chain (29) having its two ends fixed to an attachment (30) fixed to the cradle at one side thereof and at a position radially remote from the hinge. The chain is driven by reversible drives motor (31) by way of a drive sprocket (32) and is held in appropriate tension by spring loaded tension brackets (33). Microswitches (34) cooperate with the attachment (30) to define the two terminal positions of the cradle. The terminal operative position, is furthermore adjustable to ensure that the cradle and cassette carried thereby are arrested in the correct horizontal position relative to the heated plate by means of an adjustable stop (35) cooperating with the attachment (30).

As indicated above the document binder preferably includes control means for controlling operation of the document binder. Such control means are adapted to initiate jogging a predetermined time period after the cradle has arrested in its operative position, that is to say, after the spines of covers loaded in the cradle make contact With the heated plate. The control means are adapted to deactivate jogging after a predetermined period of time and to initiate movement of the cradle from its operative position to its inoperative position after a total predetermined time period from when the cradle originally arrested in its operative position.

Control means operating in this manner ensure that overheating and resultant defective binding that is well known in the trade does not occur.

It will be understood that, in use, covers having documents therein are firstly loaded into a cassette and than, with the cradle in the loading position illustrated in FIG. 2 the cassette is introduced into the cradle so that the inwardly directed lips (8) of the side wall of the cassette are supported by the inwardly directed lips (15) of the cradle (14). The drive mechanism is then activated to move the cradle to the operative position illustrated in FIGS. 1 and 4 with the heated plate between the opposite lips. In so doing the lower spines (10) of the covers engage the heated plate to become supported thereby whilst the lips move further downwards by a short distance to enable this to take. The result is shown most clearly in FIG. 5.

The heated plate then serves to melt the hot melt adhesive in the spines of the covers and, once molten, the jogger motor (28) is activated for a selected period of time, say for example, 10 seconds. The drive mechanism is then activated to move the cradle from its operative position to its loading position and the cassette can be removed and replaced with another as and when required.

It is to be mentioned that a cassette can be adjusted to accommodate covers having shorter spines than the full-length between the two lips (8) of a cassette. This is achieved by installing a transverse dividing wall (36) (see FIG. 6) in the compartments so that a shorter cover (37) is accommodated therein with the one end (9) of the spine supported by an inwardly directed lip (8) whilst the opposite end (38) of the cover engages the top (39) of the dividing wall to stop the cover from rotating about the supported end (9). It has been found that such an arrangement operates effectively in practice and enhances the versatility of the use of cassette's in that covers of different lengths can be accommodated.

It will be understood that numerous variations can be made to the embodiment of the invention described above without departing from the scope hereof.

1. A document binder of the type comprising a chassis (12) adapted to removably receive either a plurality of covers (11) with associated document pages therein with spines (10) of the covers in a generally lowermost position or to removably receive a cassette (1) configured to hold such plurality of covers, and a generally horizontal heated plate (18) that operatively engages the spines of the plurality of covers to heat same when engaged therewith in consequence of appropriate relative movement of the heated plate and spines of the covers in an upwards and downwards direction, the document binder being characterized in that it has a cradle (14) adapted to removably receive said plurality of covers or cassette containing same with the cradle being pivotally mounted (17) to the chassis so as to be pivotally movable between two positions, a first, loading position in which the cradle is positioned in an upwardly and outwardly inclined orientation for enabling a plurality of covers or a cassette containing such plurality of covers to be loaded into the cradle or removed therefrom, and a second, generally horizontal and lower operative position in which the cradle supports the covers or cassette carrying same with spines of covers carried in the cradle in contact with the heated plate.

2. A document binder as claimed in claim 1 in which the cradle is particularly configured to removably receive a cassette having a series of compartments defined between a series of spaced dividers (2).

3. A document binder as claimed in claim 1 in which the heated plate is supported by the chassis through resilient support means (20, 21) enabling it to be vibrated or jogged to effect jogging of the covers during or following a heating cycle, or both.

4. A document binder as claimed in claim 3 in which means for jogging the heated plate comprises a generally horizontal drive shaft (22) having an eccentric weight (23) thereon.

5. A document binder as claimed in claim 1 in which the pivotal axis of movement of the cradle is positioned generally horizontally and forwards of the nearest part of a compartment fo operatively receiving a cover so that pivotal movement between the operative position and the loading position lifts associated document spines off the heated plate.

6. A document binder as claimed in claim 1 in which movement of the cradle between the operative and loading positions is effected by means of a chain drive (29) positioned on one side wall of the chassis and driven by a reversible motor (31) controlled by way of limit switches (34) associated with a chain assembly.

7. A document binder as claimed in claim 1 further comprising:
control means for controlling operation of the document binder, said control means being adapted to initiate jogging a predetermined time after the cradle has arrested in its operative position in which the spines of covers that are loaded in the cradle make contact with the heated plate; to continue jogging for a predetermined period of time; and to initiate movement of the cradle from its operative position to its inoperative position after a total predetermined time period after the cradle arrested in its operative position.
